(19) United States
(12) Patent Application Publication
(10) Pub. No.: US 2007/0072598 A1
(43) Pub. Date: Mar. 29, 2007

(54) Controlling wireless communication devices with media recording capabilities

(76) Inventors: David T. Coleman, Succasunna, NJ (US); Igor Golioto, Fairfield, NJ (US)

Correspondence Address: CARLSON, GASKEY & OLDS, P.C., 400 W MAPLE RD, SUITE 350, BIRMINGHAM, MI, 48009, US

(21) Appl. No.: 11/233,695

(22) Filed: Sep. 23, 2005

(51) Int. Cl. H04Q 7/20

(52) U.S. Cl. 455/422.1

(57) ABSTRACT

A wireless communication system (20) includes the capability of controlling when a media recording device such as a camera (32) associated with a mobile station (30) may be used. In a disclosed example, if the mobile station (30) is in a restricted area where audio recordings, photographs or video are not permitted, a controller (34) automatically disables the media recording device (32) responsive to an appropriate signal from a wireless network (22) or base station (24). In one example, a controller (34) automatically marks a file containing media data if that data was acquired in a restricted area. In a disclosed example, the wireless communication network (22) prevents forwarding any media files corresponding to media acquired in a restricted area.

### FIELD OF THE INVENTION

This invention generally relates to communications. More particularly, this invention relates to wireless systems.

### DESCRIPTION OF THE RELATED ART

Wireless communication systems allow for communications between mobile stations such as cell phones or notebook computers, for example, to communicate with each other or traditional telephone devices for example. A variety of capabilities exist for different types of mobile stations. Recently, mobile stations such as cell phones have included media recording capabilities for capturing and recording video, audio or both. Known cell phone devices have a digital camera associated with them that allows an individual to take a picture, for example, using their cell phone. Additionally, such devices allow for communicating a file containing a taken picture through a wireless communication network to another device. In such instances, the file containing the picture is treated as a data file and communicated using known protocols for handling such data communications.

There are circumstances where it is advantageous or desirable to prevent an individual from communicating such media files. One example situation is in an area where security concerns exist. It is desirable to prevent individuals from taking pictures of security-sensitive areas and communicating those pictures using their mobile station to another device. Another example scenario where it may be useful to prevent an individual from using their mobile station media recording capabilities is an area where photographs or videos are restricted or not permitted. It is relatively easy to police when an individual is using a standard camera as that can be recognized by observing the individual. An individual with a cell phone having camera capabilities, however, may be able to take pictures or record video in an unauthorized manner without that being recognized by another.

It is desirable to provide techniques for controlling when an individual may use the media recording capabilities of their mobile station.

### SUMMARY OF THE INVENTION

This invention pertains to controlling media recording capabilities of mobile stations to prevent the use of such devices in selected areas or under selected circumstances. This invention provides the ability to selectively control media recording capabilities of mobile stations such as cell phones.

An exemplary disclosed method of communicating includes preventing a mobile station from communicating recorded media information if the mobile station is in a location corresponding to restricted media communications.

One example method includes disabling the media recording capability of a mobile station if the mobile station is in the restricted area.

Another example includes preventing any recorded media data transmitted from a mobile station located in the restricted area from being communicated through a wireless network.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication network including recorded media controlling capabilities designed according to an embodiment of this invention.

FIG. 2 is a flowchart diagram summarizing an example approach for controlling media recording capabilities according to an embodiment of this invention.

### DETAILED DESCRIPTION

This invention relates to controlling when a mobile station having media recording capabilities is able to acquire media data such as photographic, video, audio or multimedia data files or to communicate such files. This invention allows for controlling the capabilities of such mobile stations for protecting against unauthorized recording or distribution of corresponding data.

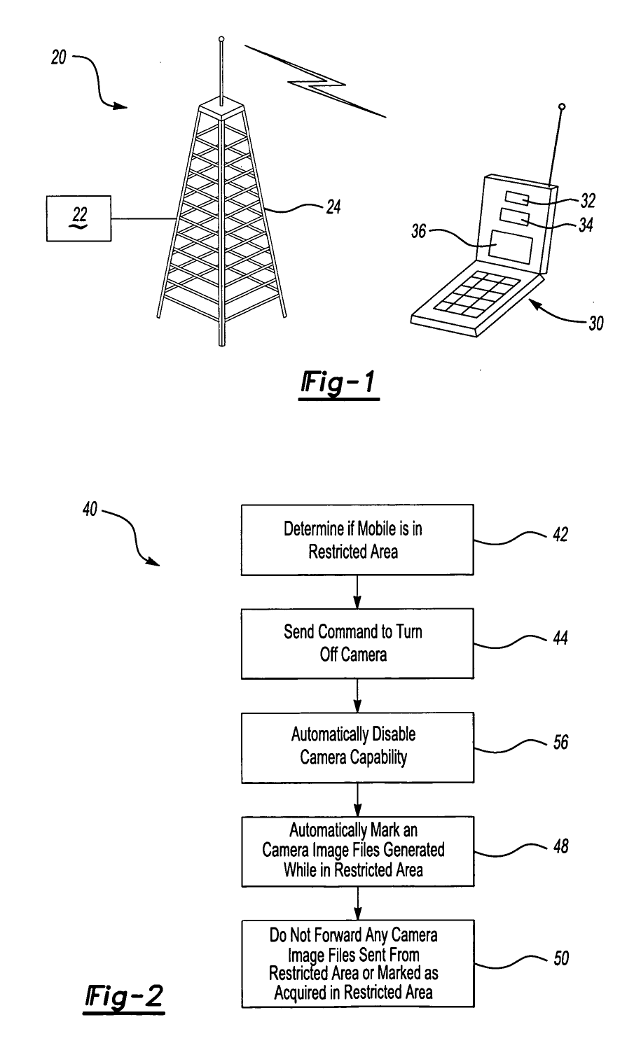

FIG. 1 schematically illustrates selected portions of a wireless communication system 20. A wireless network 22 and a base station 24 operate in a generally known manner to facilitate communications on behalf of a mobile station 30. As known, the base station 24 serves a geographic region divided into several sectors. In this example, at least one of the sectors served by the base station 24 includes a restricted area where photographs, audio recordings or video are not allowed to be taken. In one example, the restricted area is a location subject to security such as an airport or a government facility. In another example, the restricted area is a theatre or stadium where one or more types of performances are given and only authorized individuals are allowed to record (e.g., photograph or video) portions of such a performance. In another example, the restricted area is a beach. Given this description, those skilled in the art will realize how the advantages of this invention can be utilized for a variety of such restricted areas.

The example mobile station 30 includes a camera 32 and a camera controller 34 such that the mobile station 30 has camera capabilities. The camera 32 allows an individual with the mobile station 30 to take pictures or record video including audio. The camera 32 and the controller 34 generate a file containing photographic, video or other media data each time a picture or video is taken in a known manner. This description uses the terms media data or media file to refer to data or a file that comprises photographic, video, audio or other multimedia data. Example media files comprise JPEG formatted data, MPEG formatted data, video data or streaming video including audio. For discussion purposes, the following portion of this description uses a photographic data file as an example media file.

The example mobile station 30 also includes a display 36 for viewing the scene to be photographed or for viewing camera images acquired by the camera 32, for example. The display 36 also facilitates an individual using the mobile station 30 for a variety of communications in a known manner.

Whenever the mobile station 30 is within a restricted area where photographs are not permitted or only permitted by authorized individuals, the wireless network 22, the base station 24 or both provide the ability to prevent use of the camera 32 of the mobile station 30 within the restricted area.

FIG. 2 includes a flowchart diagram 40 that summarizes example techniques that are available with the illustrated example. At 42, the portion of the wireless communication system 20 that is responsible for determining the location of the mobile station 30 determines if the mobile station 30 is in a restricted area. At 44, a transceiver of the base station 24 sends a command to the mobile station 30 to turn off the camera 32 when the mobile station is in the restricted area. In one example, the mobile station 30 responds to such a signal by providing a message on the display 36 indicating that photographs are not allowed. One example message includes a statement instructing the individual with the mobile station 30 to turn off the camera 32 or to refrain from taking pictures at that location.

In another example, the display 36 will only show a message indicating that photographs are not allowed whenever the user of the mobile station attempts to use the camera 32. In this example, even if the camera is operative to take a picture, the message on the display 36 overrides any display of the camera's view. In most circumstances, this will be a significant hindrance that will prevent someone from using the camera 32 in the restricted area.

In another example, the command to turn off the camera sent at 44 in FIG. 2 is useful for automatically disabling the camera 32 of the mobile station 30. This is shown at 46 in FIG. 2 where the controller 34 responds to the command by automatically disabling the camera capability of the mobile station 30.

In one example, the base station 24 periodically sends the command to prevent use of the camera 32 as long as the mobile station 30 is within the restricted area. In another example, the command to turn off the camera is sent initially when the mobile station 30 enters the restricted area and the camera remains disabled until the system 20 determines that the mobile station 30 has left the restricted area. Once that occurs, a new command to reenable the camera capabilities of the mobile station 30 is sent by an appropriate base station and the controller 34 responds by setting the camera 32 so that it can be used as desired.

The example of FIG. 2 includes another technique for protecting against unauthorized use of the camera 32. As shown at 48, the base station 24 in this example sends a message to the mobile station 30 indicating that any photographs taken within the restricted area will be marked with an identifier indicating that the mobile station was within the restricted area when the camera image file is generated.

Another feature of the illustrated example is that the wireless network 22 will not distribute the camera image files taken in a restricted area so that the 5 mobile station 30 cannot be used to communicate such files to another device. This is shown at 50 in the example of FIG. 2 where the wireless network 22 will not forward any media files acquired in a restricted area. In one example, any attempted transmission from the mobile station 30 from a restricted area that includes a media file will be prohibited by the network 22. In another example, any media file that has been marked with an indication that the photograph (e.g., the corresponding data) was acquired in a restricted area will not be forwarded by the wireless network 22, regardless of the location of the mobile station 30 at the time of attempted transmission. Appropriate portions of the base station 24 or a radio network controller within the wireless network 22 can be provided with the capability of determining when such a transmission is attempted so that the inappropriate communication from the mobile station 30 can be prevented.

The disclosed example provides the advantage of being able to control when an individual uses media recording capabilities of a mobile station to prevent unauthorized recordings, photograph or video taking under appropriate circumstances. This allows for increased security and privacy without requiring individuals having mobile stations with such capabilities to go without their communication device within the restricted area. In other words, the disclosed example allows for individuals to carry their mobile station with such capabilities into a restricted area without a concern that they will use it in an unauthorized or inappropriate manner.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
preventing communication of media data from a restricted area.

2. The method of claim 1, comprising:
preventing a transmission including media data from the restricted area.

3. The method of claim 2, comprising:
refusing to forward the transmitted media data.

4. The method of claim 1, comprising:
determining if a mobile station is within the restricted area; and
sending a signal to the mobile station with an indication to turn off a media recording device associated with the mobile station.

5. The method of claim 4, comprising:
repeatedly sending the signal if the mobile station is in the restricted area.

6. The method of claim 4, comprising:
sending a first signal with an indication to turn off the media recording device; and
sending a subsequent signal with an indication to allow the media recording device to be turned on if the mobile station leaves the restricted area.

7. The method of claim 4, comprising:
providing an indication that the media recording device associated with the mobile station should be manually turned off.

8. The method of claim 1, comprising:
determining if a media file is generated within a restricted area; and
marking the generated media file with an indication that the file was generated in the restricted area.

9. The method of claim 8, comprising:
preventing transmission of the marked media file.

10. The method of claim 1, wherein the media file comprises at least one of audio, photograph, video or streaming video data.

11. A mobile station, comprising:
a media recording device for generating a media file containing data corresponding to media acquired by the media recording device; and
a controller for responding to a signal transmitted to the mobile station indicating a desired control of the operation of the media recording device.

12. The mobile station of claim 11, wherein the controller disables the media recording device responsive to a signal indicating that the mobile station is in a location where the media recording device cannot be used.

13. The mobile station of claim 11, wherein the controller responds to a signal indicating that the mobile station is in a restricted area by marking a file containing data corresponding to media acquired while the mobile station is in the restricted area.

14. The mobile station of claim 11, wherein the controller prevents transmission of data corresponding to media acquired while the mobile station is in a restricted area.

15. The mobile station of claim 11, comprising a display that provides an indication that the media recording device cannot be used responsive to the signal from the wireless communication network.

16. The mobile station of claim 11, wherein the media file comprises at least one of audio, photograph, video or streaming video data.

17. A wireless communication system for communicating with at least one mobile station, comprising:
at least one device that determines if the at least one mobile station is in a restricted area and prevents communication of media data from the restricted area.

18. The system of claim 17, wherein the at least one device comprises a base station.

19. The system of claim 17, wherein the at least one device prevents transmission of media data if the mobile station is in the restricted area.

20. The system of claim 17, wherein the at least one device prevents transmission of media data corresponding to a media file acquired in the restricted area.

21. The system of claim 17, wherein the at least one device communicates a signal to the mobile station indicating that media acquisition is prohibited in the restricted area.

22. The system of claim 17, wherein the at least one device communicates a signal that results in automatically disabling a media recording capability of the mobile station.
